(19) United States
(12) Patent Application Publication
(10) Pub. No.: US 2025/0334847 A1
(43) Pub. Date: Oct. 30, 2025

(54) PIXEL ARRAY SUBSTRATE STRUCTURE AND FABRICATION METHOD THEREOF AND ELECTROPHORETIC DISPLAY DEVICE

(71) Applicant: HannStar Display Corporation, Taipei City (TW)

(72) Inventors: Qi-En LUO, Taipei City (TW); Shao-Chien CHANG, Taipei City (TW); Yu-Tuan HSU, Taipei City (TW); Jing-Ya CHIU, Taipei City (TW); Mu-Kai KANG, Taipei City (TW)

(21) Appl. No.: 18/988,858

(22) Filed: Dec. 19, 2024

(30) Foreign Application Priority Data
Apr. 24, 2024 (TW) 113115181

(51) Int. Cl. G02F 1/167; G02F 1/1676

(52) U.S. Cl. CPC G02F 1/167; G02F 1/1676

(57) ABSTRACT

A pixel array substrate structure includes a substrate, a first metal layer, a second metal layer, a shielding electrode layer, and a pixel electrode layer. The first metal layer is over the substrate and has scan lines. The second metal layer is over the first metal layer and has data lines. The scan lines and the data lines define pixel areas. The shielding electrode layer is over the second metal layer and includes shielding electrodes. The shielding electrodes are in the pixel areas, respectively, and cover the scan lines and the data lines in the vertical projection direction of the substrate. The pixel electrode layer is over the shielding electrode layer and has pixel electrodes. The pixel electrodes are in the pixel areas, respectively.

### RELATED APPLICATIONS

This application claims priority to Taiwan Application Serial Number 113115181 filed Apr. 24, 2024, which is herein incorporated by reference.

### BACKGROUND

### Field of Invention

The invention relates to a display device, and more particularly to a pixel array substrate structure, a fabrication method thereof and an electrophoretic display device.

### Description of Related Art

The electrophoretic display device is a type of display device, which is characterized by extremely low power consumption except for when changing the displayed images, and by the ability to utilize ambient light or front light as the display light source. Therefore, electrophoretic display devices have the advantage of saving power compared with liquid crystal display devices. However, conventional electrophoretic display devices have an issue of light leakage in dark states. Specifically, when a conventional electrophoretic display device displays a dark image (e.g., a black image), the black driving range of each pixel is not complete enough, so that a part of the ambient light is reflected inside the electrophoretic display device before it emits, that is, light leakage occurs, which results in a degradation in the contrast.

### SUMMARY

The present disclosure provides a pixel array substrate structure, a fabrication method thereof and an electrophoretic display device which can reduce the interference between the pixel electrodes and the data lines and/or the scan lines, and at the same time increase the layout area of the pixel electrodes so as to reduce the light leakage of white light reflection, and thereby improve the contrast.

An aspect of the present disclosure provides a pixel array substrate structure including a substrate, a first metal layer over the substrate, a second metal layer over the first metal layer, a shielding electrode layer over the second metal layer and a pixel electrode layer over the shielding electrode layer. The first metal layer includes a plurality of scan lines. The second metal layer includes a plurality of data lines, and the plurality of scan lines and the plurality of data lines define a plurality of pixel areas. The shielding electrode layer includes a plurality of shielding electrodes that are located in the plurality of pixel areas, respectively, and cover the plurality of scan lines and the plurality of data lines in a vertical projection direction of the substrate. The pixel electrode layer has a plurality of pixel electrodes that are located in the plurality of pixel areas, respectively.

In accordance with one embodiment of the invention, one of the plurality of pixel electrodes overlaps at least one of the plurality of scan lines in the vertical projection direction.

In accordance with another embodiment of the present disclosure, an edge of one of the plurality of pixel electrodes is aligned with an edge of one of the plurality of data lines in the vertical projection direction.

In accordance with another embodiment of the present disclosure, one of the plurality of pixel electrodes overlaps at least one of the plurality of data lines in the vertical projection direction.

In accordance with another embodiment of the present disclosure, a width of a spacing between two of the plurality of pixel electrodes that are adjacent to each other is less than or equal to 5 μm.

In accordance with another embodiment of the present disclosure, the pixel array substrate structure further includes a first pixel transistor and a second pixel transistor. A source of the first pixel transistor is coupled to one of the plurality of data lines. A drain of the first pixel transistor is coupled to a source of the second pixel transistor. A drain of the second pixel transistor is coupled to one of the plurality of pixel electrodes, and a gate of the first pixel transistor and a gate of the second pixel transistor are coupled to one of the plurality of scan lines.

In accordance with another embodiment of the present disclosure, the second metal layer further has a plurality of scanning signal lines that are coupled to the plurality of scan lines, respectively, and the plurality of scanning signal lines are substantially parallel to the plurality of data lines.

In accordance with another embodiment of the present disclosure, the first metal layer further has a plurality of first capacitor electrodes, and the second metal layer further has a plurality of second capacitor electrodes. The plurality of first capacitor electrodes and the plurality of second capacitor electrodes are located in the plurality of pixel areas.

Another aspect of the present disclosure provides an electrophoretic display device including the pixel array substrate structure, an opposite substrate structure and an electrophoretic layer. The opposite substrate structure includes a second substrate and a common electrode layer disposed on the second substrate, and the electrophoretic layer is between the pixel electrode layer and the common electrode layer.

Still another aspect of the present disclosure provides a fabrication method of a pixel array substrate structure. The fabrication method includes forming a first metal layer over a substrate, and the first metal layer has a plurality of scan lines. The fabrication method includes forming a second metal layer over the first metal layer, and the second metal layer has a plurality of data lines. The plurality of scan lines and the plurality of data lines define a plurality of pixel areas. The fabrication method includes forming a shielding electrode layer over the second metal layer, and the shielding electrode layer includes a plurality of shielding electrodes that are located in the plurality of pixel areas, respectively, and the plurality of shielding electrodes cover the plurality of scan lines and the plurality of data lines in a vertical projection direction of the substrate. The fabrication method includes forming a pixel electrode layer over the shielding electrode layer, and the pixel electrode layer has a plurality of pixel electrodes that are located in the plurality of pixel areas.

In accordance with another embodiment of the present disclosure, the fabrication method further includes forming a passivation material layer over the second metal layer. The fabrication method further includes forming an overcoat layer having a via over the passivation material layer. The fabrication method further includes forming another passivation material layer over the shielding electrode layer and forming a through hole in the passivation material layer and the another passivation material layer. The through hole passes through the passivation material layer and the another passivation material layer, and the through hole overlaps the via in the vertical projection direction.

The beneficial effect of the present disclosure is at least that the interference between the pixel electrodes and the data lines and/or the scan lines can be improved, and at the same time, the layout area of the pixel electrodes can be increased so as to reduce the light leakage of white light reflection, and thereby improve the contrast.

### BRIEF DESCRIPTION OF THE DRAWINGS

The invention can be more fully understood by reading the following detailed descriptions of the exemplary embodiments, with reference made to the accompanying drawings as follows.

FIG. 1 is a schematic diagram of a display device in accordance with various embodiments of the invention.

FIG. 2 is a cross-sectional view of a pixel of a display panel in accordance with various embodiments of the invention.

FIG. 3A is a schematic layout diagram of a pixel array substrate structure shown in FIG. 2.

FIG. 3B is a cross-sectional view of the schematic layout diagram along line A-A′ of FIG. 3A.

FIG. 4A is a schematic layout diagram of a first metal layer, a semiconductor layer, a through hole and a second metal layer in FIG. 3A.

FIG. 4B is a schematic layout diagram of a via, a shielding electrode layer, the through hole and a pixel electrode layer in FIG. 3A.

FIG. 5 is another schematic layout diagram of the pixel array substrate structure shown in FIG. 2.

FIG. 6A is a schematic diagram of the pixels of the display panel in FIG. 2 in a dark state.

FIG. 6B is a schematic diagram of the pixels of display panels in the prior art in a dark state.

FIG. 7A is a schematic diagram of a processing table of each step for fabrication of the pixel array substrate structure in FIG. 2.

FIG. 7B is a schematic diagram of another processing table of each step for fabrication of the pixel array substrate structure in FIG. 2.

FIG. 8A to FIG. 8H are cross-sectional views and overlapping diagrams of photomasks of each step for fabrication of the pixel array substrate structure in FIG. 2.

FIG. 9 is a schematic layout diagram of the pixel array substrate structure in accordance with the other embodiments of the invention.

### DETAILED DESCRIPTION

Specific embodiments of the invention are further described in detail below with reference to the accompanying drawings. However, these exemplary embodiments described are not intended to limit the invention and it is not intended for the description of operation to limit the order of implementation.

Terms used herein are only used to describe the specific embodiments, which are not used to limit the claims appended herewith. Unless the context clearly dictates otherwise and/or otherwise limited, the terms “a,” “an,” or “the” of the singular form may also include plural reference.

It will be understood that, although the terms “first,” “second,” etc., may be used herein to describe various features, these features should not be limited by these terms. These terms are only used to distinguish a feature from another feature.

The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

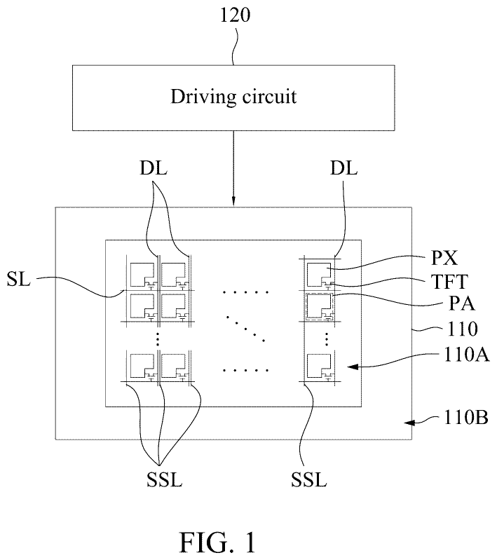

FIG. 1 is a schematic diagram of a display device 100 in accordance with various embodiments of the invention. The display device 100 includes a display panel 110 and a driving circuit 120. The display panel 110 may be a liquid crystal display panel of various types or another suitable display panel. The driving circuit 120 is electrically connected to the display panel 110. The driving circuit 120 may include a source driving circuit and a gate driving circuit. The source driving circuit is configured to convert image data into source driving signals and to transmit the source driving signals to the display panel 110, while the gate driving circuit is configured to generate and transmit gate driving signals to the display panel 110.

The display panel 110 has an active area 110A and a peripheral area 110B. Data lines DL, scan lines SL, and pixels PX are in the active area 110A. The data lines DL are sequentially disposed along an X-direction, while the scan lines SL are sequentially disposed along a Y-direction. Pixel areas PA are defined by the scan lines SL and the data lines DL. The pixels PX have pixel transistors TFT (i.e., thin film transistors TFTs), respectively, and the pixel transistor TFT of each pixel PX is electrically connected to one of the scan lines SL, one of the data lines DL and one of the pixel electrodes (i.e., the pixel electrode in the same pixel PX). The pixels PX are located in the pixel areas PA and are driven to display an image by the source driving signals and the gate driving signals. The peripheral area 110B has wirings (not shown) which are respectively coupled to the driving circuit 120 and respectively coupled to the data lines DL and the scan lines SL in the active area 110A, so as to send the source driving signals and the gate driving signals (i.e., the pixel signals and the scan signals) respectively to the pixel transistors TFT of the pixels PX, so that the pixels PX are controlled by switching of the pixel transistors TFT to display corresponding images at a specific time. In some embodiments, the display panel 110 may further include scan signal lines SSL which are coupled to the gate driving circuit of the driving circuit 120 and respectively coupled to the scan lines SL as shown in FIG. 1, so that the gate driving signals are respectively transmitted to the scan lines SL by the scan signal lines SSL. Thus, the source driving signals and the gate driving signals are input from the same side of the active area 110A (e.g., the top side or the bottom side of the active area 110A) into the active area 110A, or are input from two opposite sides of the active area 110A (e.g., the top side and the bottom side of the active area 110A) into the active area 110A. In the prior art, the gate driving circuit is disposed on the left and right sides of the active area 110A and is coupled to the scan lines SL, and thus, it is not possible to form a display panel with a narrow bezel. Since the extending direction of the scan signal lines SSL of this disclosure is substantially parallel to the extending direction of the data lines DL, it is not necessary to dispose the gate driving circuit on the left and right sides of the active area 110A, such that the width of the peripheral area 110B in the display panel 110 is reduced and a display panel with a narrow bezel is formed.

In some embodiments, both of the fabrication processes of the source driving circuit and the gate driving circuit in the driving circuit 120 can be separated from the fabrication process of the display panel 110, or at least one of the fabrication processes of the source driving circuit and the gate driving circuit in the driving circuit 120 can be integrated into the fabrication process of the display panel 110. In some embodiments, at least a part of the driving circuit 120 is formed on the peripheral area 110B of the display panel 110, and thus, the display panel 110 and the electronic components of the driving circuit 120 may be simultaneously formed by using the same process. For example, the thin film transistors in the driving circuit 120 may be simultaneously formed by using the same process as the pixel transistors TFT in the active area 110A of the display panel 110. As a result, the electronic components and wirings in the display panel 110 and the driving circuit 120 may be simultaneously formed by using the same process.

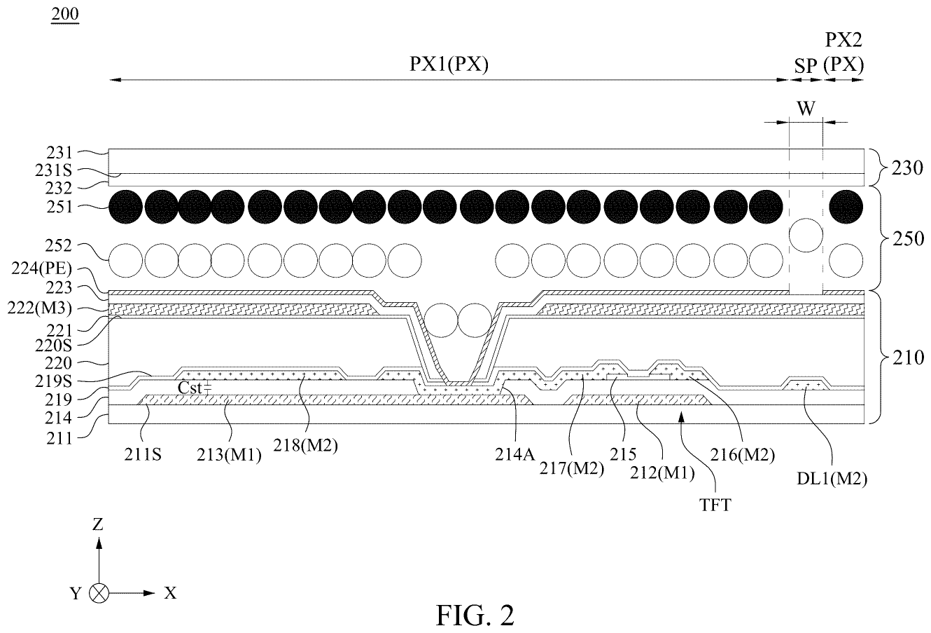

FIG. 2 is a cross-sectional view of a pixel of a display panel 200 in accordance with various embodiments of the invention. The display panel 200 may be the same as the display panel 110 shown in FIG. 1, accordingly, the pixels PX in FIG. 2 may be parts of two pixels PX (the pixel PX1 and the pixel PX2 which are respectively located at the left side and the right side of the data line DL1, as shown in FIG. 2) that are adjacent to each other in the corresponding display panel 110. Specifically, since the cross-sectional view of the pixel PX2 is similar to the cross sectional view of the pixel PX1, FIG. 2 illustrates only a part of the pixel PX2. A spacing SP is located between the pixel PX1 and the pixel PX2 that are adjacent to each other, and the spacing SP has a width W. As shown in FIG. 2, the display panel 200 includes a pixel array substrate structure 210 and an opposite substrate structure 230 which are opposite to each other and includes an electrophoretic layer 250 between the pixel array substrate structure 210 and the opposite substrate structure 230.

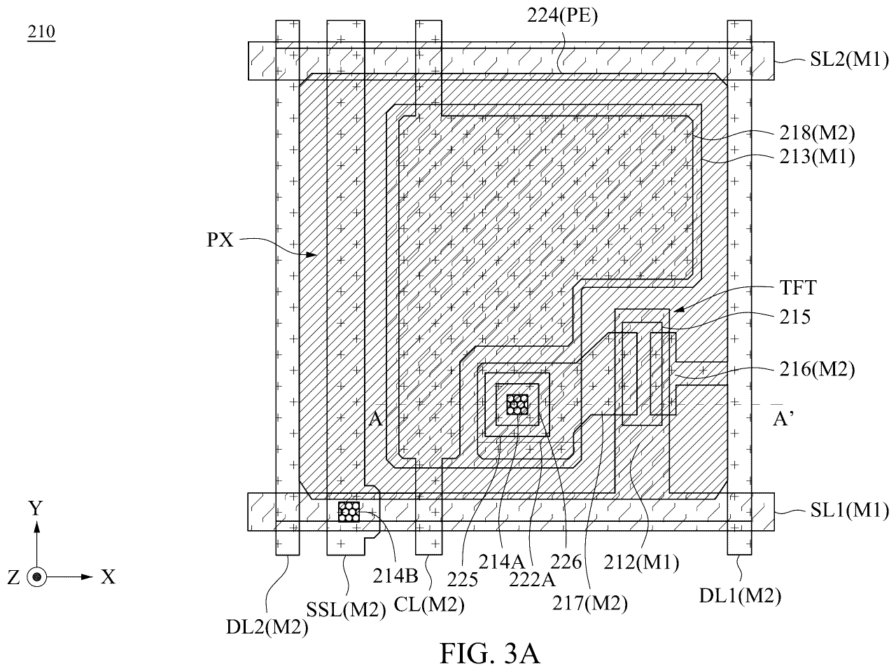

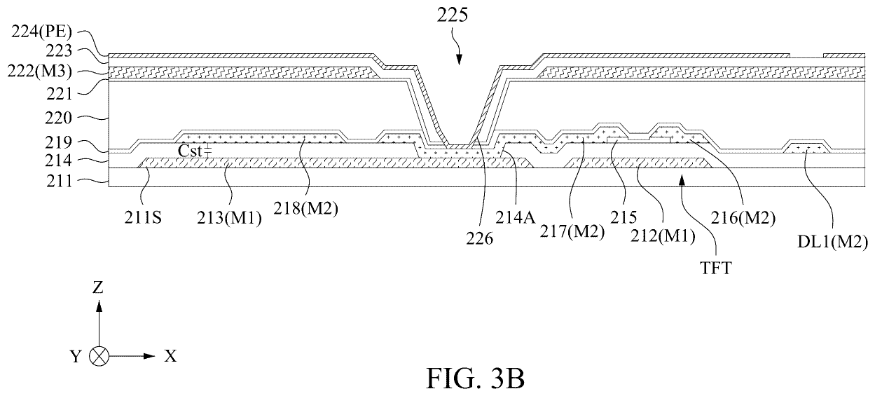

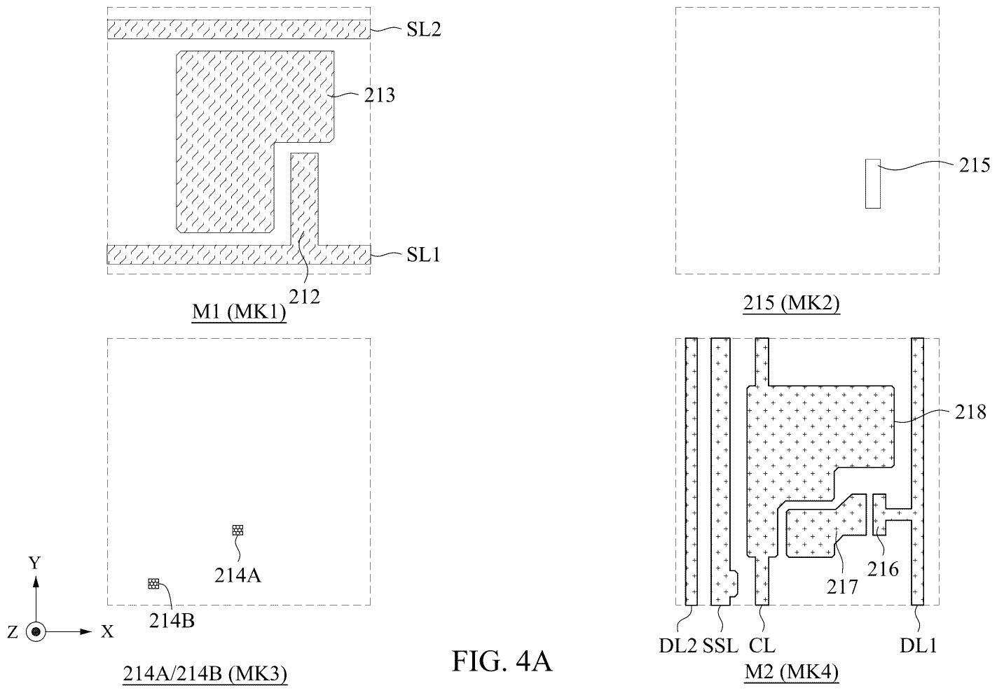

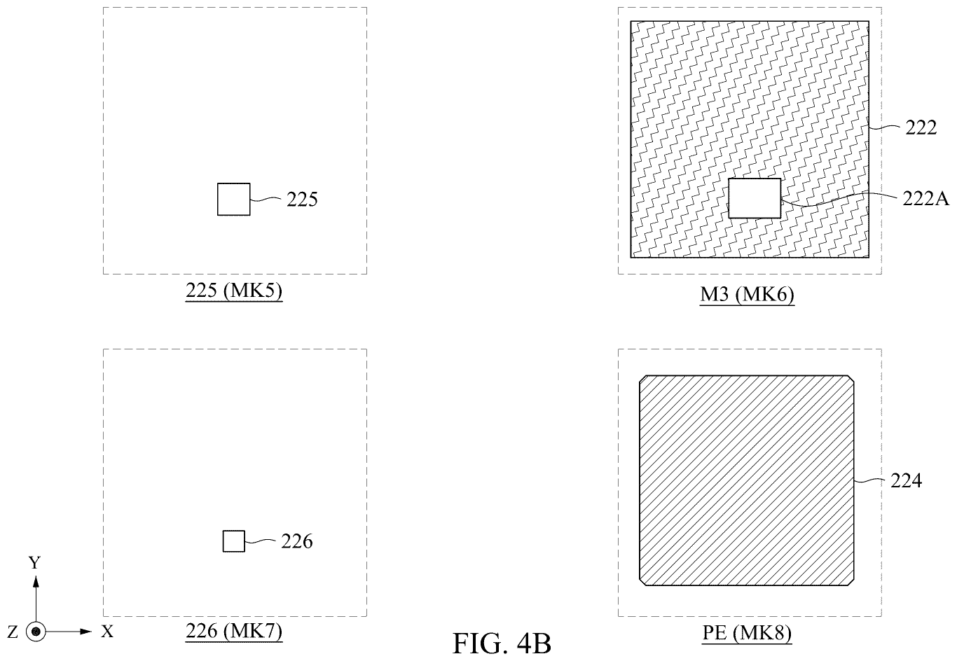

FIG. 3A is a schematic layout diagram of the pixel array substrate structure 210 shown in FIG. 2, and FIG. 3B is a cross-sectional view of the schematic layout diagram along line A-A′ of FIG. 3A. Specifically, the cross-sectional view of FIG. 3B is the same as the cross-sectional view of the pixel array substrate structure 210 in FIG. 2. FIG. 4A is a schematic layout diagram of a first metal layer M1, a semiconductor layer 215, a through hole 214A, a through hole 214B and a second metal layer M2 shown in FIG. 3A. FIG. 4B is a schematic layout diagram of a via 225, a shielding electrode layer M3, a through hole 226 and a pixel electrode layer PE shown in FIG. 3A. It should be noted that FIG. 3A is a schematic layout diagram of the pixel array substrate structure 210 on the XY-plane (i.e., the plane formed of the X-direction and the Y-direction), while the Z-direction is perpendicular to the XY-plane. In addition, FIG. 3A omits a first substrate 211, a gate insulation layer 214, a first passivation layer 219, an overcoat layer 220, a second passivation layer 221 and a third passivation layer 223 which are illustrated in FIG. 2 and FIG. 3B. In order to simplify the description, FIG. 3A illustrates one pixel PX and its surrounding wirings, and a person having ordinary skill in the art to which the disclosure pertains should understand that the other pixels and their wirings may be identical or similar to what is shown in FIG. 3A.

Reference is made to FIG. 1 to FIG. 4B. As shown in FIG. 1 and FIG. 3A, the scan lines SL include a first scan line SL1 and a second scan line SL2, while the data lines DL include a first data line DL1 and a second data line DL2. The first scan line SL1 and the second scan line SL2 intersect the first data line DL1 and the second data line DL2 to define the pixel area PA, and the pixel PX is in the pixel area PA in a vertical projection direction of the first substrate 211. The scan signal line SSL is electrically connected to the first scan line SL1 and is substantially parallel to the first data line DL1 and the second data line DL2.

In the pixel array substrate structure 210, the first metal layer M1 is over the first substrate 211 in the Z-direction, and the first metal layer M1 includes a gate 212 of the pixel transistor TFT, the scan lines SL and a first capacitor electrode 213 (i.e., the gate 212 of the pixel transistor TFT, the scan lines SL, and the first capacitor electrode 213 belong to the same layer). The gate 212 of the pixel transistor TFT is electrically connected to the scan line SL, while the scan line SL is configured to provide scan signals to the gate 212 of the pixel transistor TFT. In the embodiment, the Z-direction is perpendicular to a surface 211S of the first substrate 211. The Z-direction may be referred as the direction normal to the surface 211S or the vertical projection direction of the first substrate 211, where the surface 211S of the first substrate 211 faces the electrophoretic layer 250. The gate insulation layer 214 and the semiconductor layer 215 are sequentially over the first substrate 211 and the gate 212 in the Z-direction.

The second metal layer M2 is over the gate insulation layer 214 and the semiconductor layer 215 in the Z-direction, and the second metal layer M2 includes a source 216 and a drain 217 of the pixel transistor TFT, the data lines DL, the scan signal line SSL, a common line CL and a second capacitor electrode 218 (i.e., the source 216 and the drain 217 of the pixel transistor TFT, the data lines DL, the scan signal line SSL, the common line CL and the second capacitor electrode 218 belong to the same layer). The drain 217 of the pixel transistor TFT is electrically connected to the first capacitor electrode 213 through the through hole 214A, while the scan signal line SSL is electrically connected to the scan line SL through the through hole 214B. The common line CL is electrically connected to the second capacitor electrode 218, and the source 216 of the pixel transistor TFT is electrically connected to the data lines DL. The gate 212, the source 216, the drain 217, the semiconductor layer 215 and a part of the gate insulation layer 214 form the pixel transistor TFT, and the pixel transistor TFT and the second capacitor electrode 218 are in the pixel area PA.

The first passivation layer 219 is over the first metal layer M1, the gate insulation layer 214, the semiconductor layer 215 and the second metal layer M2 in the Z-direction. The overcoat layer 220 is over the first metal layer M1, the gate insulation layer 214, the semiconductor layer 215, the second metal layer M2 and the first passivation layer 219 in the Z-direction. The overcoat layer 220 may also be referred to as a flat layer. The overcoat layer 220 may reduce the unevenness of the surface 219S of the first passivation layer 219, that is, the unevenness of the surface 220S of the overcoat layer 220 (i.e., the top surface 220S of the overcoat layer 220) is less than the unevenness of the surface 219S of the first passivation layer 219 (i.e., the top surface 219S of the first passivation layer 219). In other words, the surface 220S of the overcoat layer 220 is flatter than the surface 219S of the first passivation layer 219. The surface 219S of the first passivation layer 219 faces the electrophoretic layer 250, and the surface 220S of the overcoat layer 220 faces the electrophoretic layer 250. The thickness of the overcoat layer 220 in the Z-direction is larger than the thickness of the first passivation layer 219 in the Z-direction, but the disclosure is not limited thereto.

A second passivation layer 221 is over the first metal layer M1, the gate insulation layer 214, the semiconductor layer 215, the second metal layer M2 and the overcoat layer 220 in the Z-direction. The shielding electrode layer M3 is over the second metal layer M2, the first passivation layer 219, the overcoat layer 220 and the second passivation layer 221 in the Z-direction. A third passivation layer 223 is over the second passivation layer 221 and the shielding electrode layer M3 in the Z-direction. It should be noted that, in some embodiments, in order to simplify the process and reduce cost, the second passivation layer 221 of the pixel array substrate structure 210 may be omitted. The pixel electrode layer PE is over the third passivation layer 223 in the Z-direction. The pixel electrode layer PE has pixel electrodes 224 which are located in the pixel area PA in the Z-direction. In some embodiments, the shielding electrode layer M3 includes shielding electrodes 222 which are respectively in pixel area PA in the Z-direction, and the shielding electrodes 222 cover the data lines DL, the scan lines SL and the scan signal line SSL in the vertical projection direction of the first substrate 211. Thus, the shielding electrodes 222 may shield the pixel electrodes 224 from the interference of the signals of the data lines DL, the scan lines SL and the scan signal line SSL. In addition, in some embodiments, the shielding electrodes 222 overlap the pixel transistors TFT in the Z-direction, so as to prevent the pixel transistors TFT from electrical leakage which is caused by the potential of the pixel electrodes 224.

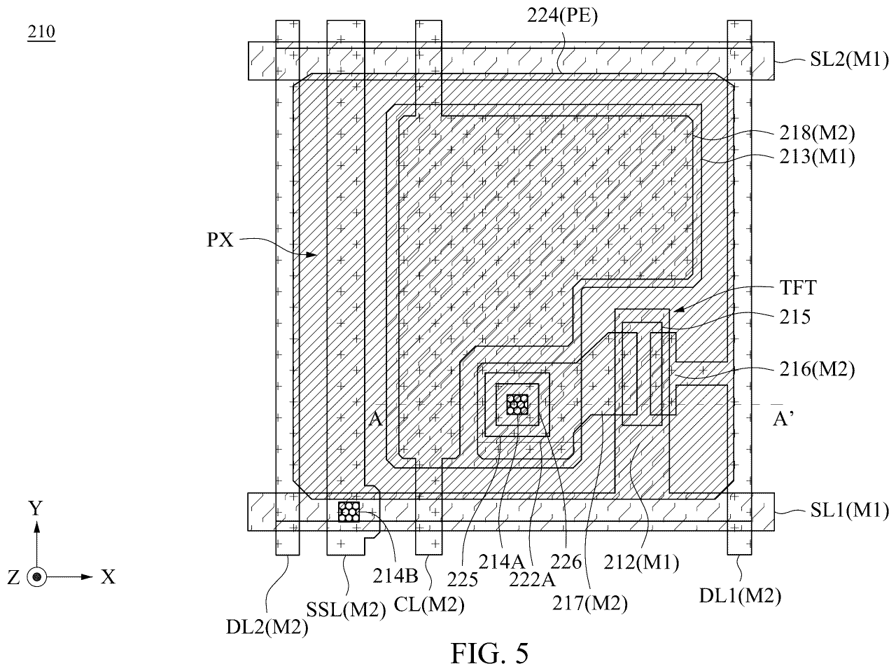

Since the shielding electrodes 222 may shield the pixel electrodes 224 from the interference of the signals of the data lines DL, the scan lines SL and the scan signal line SSL, the plane area of the pixel electrodes 224 may increase. In the embodiment, the pixel electrode 224 may overlap at least one of the scan lines SL. In addition, at least one of two edges of the pixel electrode 224 may be aligned with at least one edge of at least one of the data lines DL1, DL2, or the pixel electrode 224 may overlap at least one of the data lines DL1, DL2. As shown in FIG. 3A, the pixel electrode 224 may extend along the Y-direction and the reverse Y-direction so as to overlap the scan lines SL. The pixel electrode 224 may extend along the X-direction and the reverse X-direction such that the pixel electrode 224 may overlap the scan signal line SSL and two edges of the pixel electrode 224 may be respectively aligned with an edge of the data line DL1 and an edge of the data line DL2 in the vertical projection direction, but the disclosure is not limited thereto. FIG. 5 is another schematic layout diagram of the pixel array substrate structure 210 shown in FIG. 2. Referring to FIG. 3A and FIG. 5, the difference between FIG. 5 and FIG. 3A is that the pixel electrode 224 in FIG. 5 may extend along the X-direction and the reverse X-direction so as to overlap a part of the data line DL1 and a part of the data line DL2 in the vertical projection direction. Since the area of the pixel electrode 224 of each pixel PX may expand, the spacing SP between two pixels PX adjacent to each other may decrease. In some embodiments, the spacing SP between two pixels PX adjacent to each other may be a spacing between two pixel electrodes 224 of the adjacent pixels PX. Thus, the width W of the spacing between two pixel electrodes 224 of the adjacent pixels PX may decrease. In the pixel electrode layer PE, each width W of the spacing between every two adjacent pixel electrodes 224 may be, but is not limited to being, less than or equal to 5 μm. For example, the width W of the spacing may be a value between 3 μm and 5 μm.

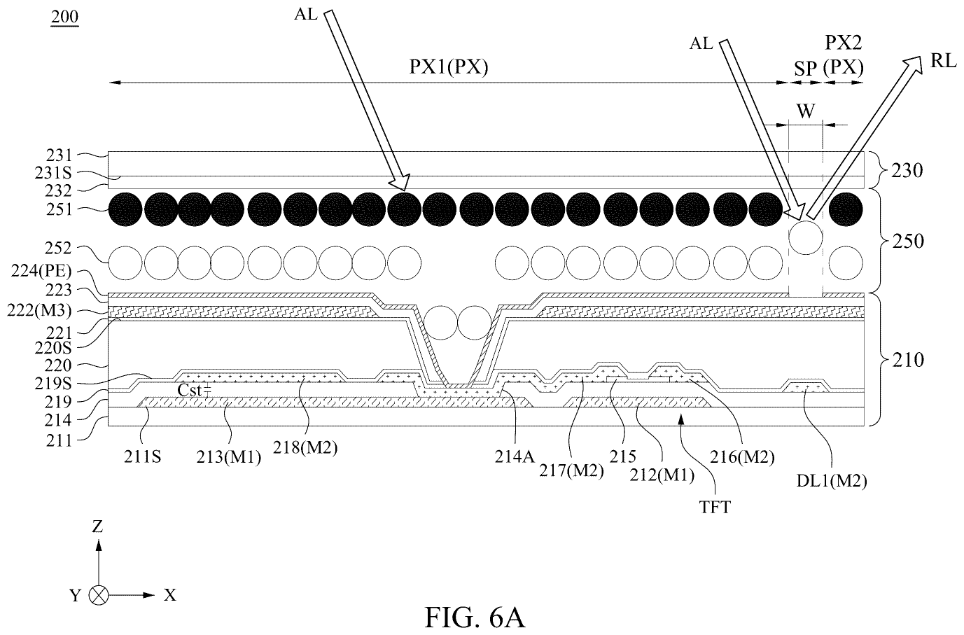

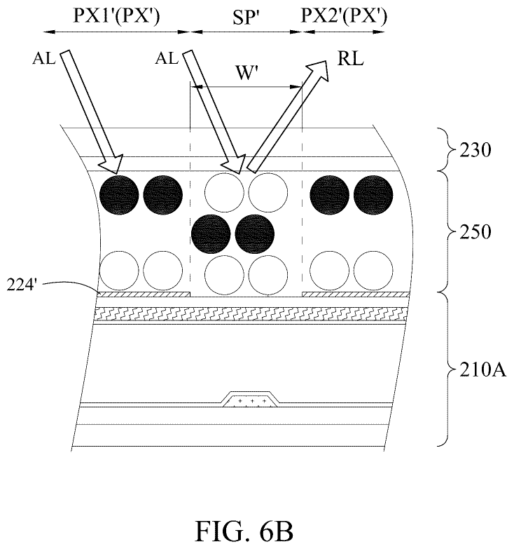

In the following description, the advantage of the decrease of width W of the spacing between two pixel electrodes 224 of the adjacent pixels PX that is caused by shielding the pixel electrodes 224 from the interference of the data lines DL, the scan lines SL and the scan signal line SSL with the shielding electrodes 222 is described. FIG. 6A is a schematic diagram of the pixel PX of the display panel 200 in FIG. 2 in a dark state. FIG. 6B is a schematic diagram of the pixel of a display panel in the prior art in a dark state. Referring to FIG. 6A and FIG. 6B, the electrophoretic layer 250 which includes first electrophoretic particles 251 and second electrophoretic particles 252 is disposed between the opposite substrate structure 230 and the pixel array substrate structure 210 (or a pixel array substrate structure 210A). The electrical polarities of the first electrophoretic particles 251 and the second electrophoretic particles 252 are opposite. For example, when the first electrophoretic particles 251 and the second electrophoretic particles 252 are positive and negative, respectively, and the potential of the pixel electrodes 224 is higher than the potential of a common electrode layer 232, the first electrophoretic particles 251 are prone to move toward the opposite substrate structure 230, while the second electrophoretic particles 252 are prone to move toward the pixel array substrate structure 210. In addition, the first electrophoretic particles 251 and the second electrophoretic particles 252 may be black particles and white particles, respectively. In the prior art, since the signals of the data lines and the scan lines would interfere with the pixel electrodes 224′ of the pixel array substrate structure 210A, the area of the pixel electrodes 224′ needs to be smaller so as to be farther away from the data lines and the scan lines. Thus, the spacing SP' between two adjacent pixels PX′ is larger. That is, the width W′ of the spacing between the pixel electrodes 224′ is larger, so that the quantity of the electrophoretic particles which are distributed in the spacing SP′ between two adjacent pixels PX′ (i.e., the pixel PX1′ and the pixel PX2′) would be larger. Since the width W of the spacing between two pixel electrodes 224 of the adjacent pixels PX in this disclosure is smaller, the quantity of the electrophoretic particles which are distributed in the spacing SP between two adjacent pixels PX is also smaller. As shown in FIG. 6A and FIG. 6B, since the pixels PX and the pixels PX′ are in a dark state, the first electrophoretic particles 251 (i.e., the black particles) in the pixel areas of the pixels PX and the pixels PX′ are located at the side of the opposite substrate structure 230, while the ambient light or the front light AL is absorbed by the first electrophoretic particles 251 so as to form the dark state. Since the electrophoretic particles in the area (i.e., the invalidly driven area) that is located between the pixel electrodes of two adjacent pixels are uncontrollable by the pixel electrodes, the white particles in the invalidly driven area in the dark state reflect the ambient light or the front light AL, so that the reflective light RL is generated, thereby leading to dark-state light leakage. The quantity of the electrophoretic particles between the pixel electrodes of two adjacent pixels in this disclosure is smaller than the quantity of the electrophoretic particles in the prior art. Thus, the dark-state light leakage of the electrophoretic display device may be reduced significantly so as to improve the contrast.

Reference is made to FIG. 1 to FIG. 4B. As shown in FIG. 2, FIG. 3A, FIG. 3B and FIG. 4A, the overcoat layer 220 has the via 225 which passes through the overcoat layer 220. As shown by the through hole 226 of FIG. 2, FIG. 3A, FIG. 3B and FIG. 4B, the first passivation layer 219, the second passivation layer 221 and the third passivation layer 223 has the through hole 226, while the through hole 226 passes through the first passivation layer 219, the second passivation layer 221 and the third passivation layer 223 and exposes at least a part of the drain 217 of the pixel transistor TFT. In the embodiment which omits the second passivation layer 221, the first passivation layer 219 and the third passivation layer 223 have the through hole 226, and the through hole 226 passes through the first passivation layer 219 and the third passivation layer 223 and exposes at least a part of the drain 217 of the pixel transistor TFT. In addition, the through hole 226 overlaps the pixel electrode 224 and the via 225 in the Z-direction. Specifically, the pixel electrode 224 is coupled to the drain 217 of the pixel transistor TFT through the via 225 and the through hole 226.

Furthermore, the potential of the shielding electrodes 222 may be identical to the potential of the second capacitor electrode 218 and the common line CL, but the disclosure is not limited thereto. In other embodiments, the potential of the shielding electrodes 222 may be different from the potential of the second capacitor electrode 218 and the common line CL. The pixel electrodes 224, the drain 217 of the pixel transistor TFT and the first capacitor electrode 213 are electrically connected to each other, and their potentials are identical.

In the opposite substrate structure 230, the common electrode layer 232 is over the surface 231S of a second substrate 231, while the surface 231S of the second substrate 231 faces the electrophoretic layer 250. In some embodiments, the opposite substrate structure 230 may further include color resists or other films (not shown). The potential of the common electrode layer 232 may be identical to the potential of the second capacitor electrode 218 and the common line CL, but the disclosure is not limited thereto. In other embodiments, the potential of the common electrode layer 232 may be different from the potential of the second capacitor electrode 218 and the common line CL.

As shown in FIG. 3A, FIG. 3B and FIG. 4A, in the direction of the plane of the pixel array substrate structure 210 (i.e., the XY-plane), the adjacent data line DL2, data line DL1 and the adjacent scan line SL2, scan line SL1 are on the top and bottom sides and on the left and right sides of the pixel PX, respectively. The scan signal line SSL is between the data line DL1 and the data line DL2 and near to the data line DL2. The common line CL is between the scan signal line SSL and the data line DL1, while the common lines CL of the adjacent pixels PX may be electrically connected to each other.

As shown in FIG. 4A, the gate 212 of the pixel transistor TFT is electrically connected to the scan line SL1 corresponding thereto, and the layout pattern of the first capacitor electrode 213 is a rectangle with an indented corner (the indented corner corresponds to the layout area of the pixel transistor TFT), but the disclosure is not limited thereto. The first capacitor electrode 213 is electrically connected to the common line CL. As shown in FIG. 3A, FIG. 3B and FIG. 4, the projection of the semiconductor layer 215 on the first substrate 211 is within the projection of the gate 212 on the first substrate 211. The gate insulation layer 214 has the through hole 214A and the through hole 214B. The through hole 214B exposes a part of the scan line SL1, while the through hole 214A exposes a part of the first capacitor electrode 213. The projection of the second capacitor electrode 218 on the first substrate 211 is within the projection of the first capacitor electrode 213 on the first substrate 211, and the shape of the second capacitor electrode 218 is not limited to the embodiment in FIG. 4A. As shown in FIG. 2, FIG. 3A and FIG. 3B, the second capacitor electrode 218 is disposed over and overlaps the first capacitor electrode 213 in the Z-direction. Thus, the second capacitor electrode 218, the first capacitor electrode 213 and the gate insulation layer 214 which is between the second capacitor electrode 218 and the first capacitor electrode 213 may form a capacitor Cst. The first capacitor electrode 213 and the second capacitor electrode 218 may receive the pixel signals and the common signals, respectively. In some embodiments, the spacing between the edge of the second capacitor electrode 218 and the edge of the first capacitor electrode 213 may be in the range of 1.5 μm to 2.5 μm when viewed in the vertical projection direction of the first substrate 211, but the disclosure is not limited thereto. The drain 217 of the pixel transistor TFT is coupled to the first capacitor electrode 213 through the through hole 214A, and the scan signal line SSL is coupled to the scan line SL1 through the through hole 214B.

As shown in FIG. 2 to FIG. 4B, the overcoat layer 220 has the via 225. The projection of the via 225 on the first substrate 211 is overlapped with the projection of the through hole 214A on the first substrate 211, while the via 225 overlaps the drain 217 of the pixel transistor TFT in the Z-direction. In addition, the via 225 overlaps the first capacitor electrode 213 in the Z-direction, but the disclosure is not limited thereto. In some embodiments, the through hole 214A, the via 225 and the through hole 226 overlap each other in the Z-direction, but the disclosure is not limited thereto. In another embodiment, the via 225 and the through hole 226 overlap each other in the Z-direction, while the through hole 214A does not overlap the via 225 and the through hole 226 in the Z-direction. The shielding electrode 222 covers the data lines DL, the scan lines SL, the scan signal line SSL and the pixel transistor TFT in the Z-direction, that is, the projection of the shielding electrode 222 on the first substrate 211 overlaps the projections of the data lines DL, the scan lines SL, the scan signal line SSL and the pixel transistor TFT on the first substrate 211. In some embodiments, the shielding electrode 222 has an opening 222A whose projection overlaps the projections of the through hole 226 and the via 225 on the first substrate 211. The layout pattern of the pixel electrode 224 is approximately formed as a rectangle, but the shape of the pixel electrode 224 is not limited to being rectangular. In some embodiments, the area of the opening 222A of the shielding electrode 222 is larger than the area of the through hole 226 and the area of the via 225.

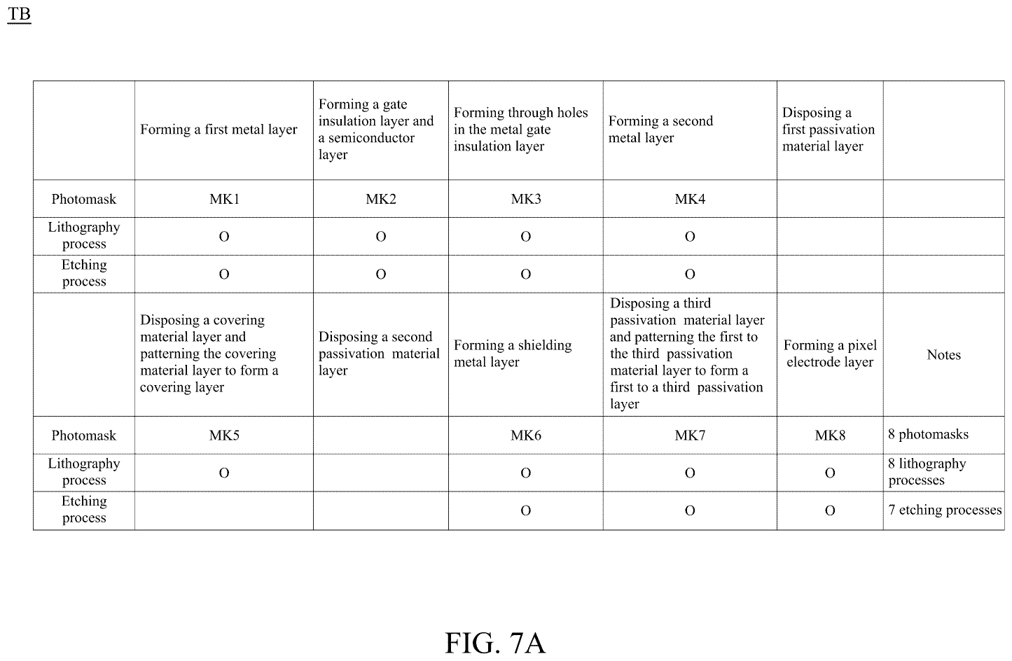

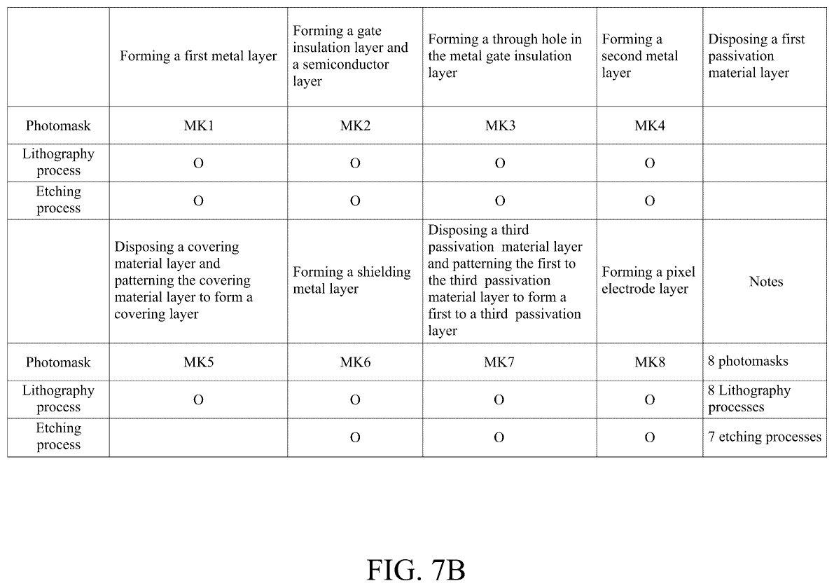

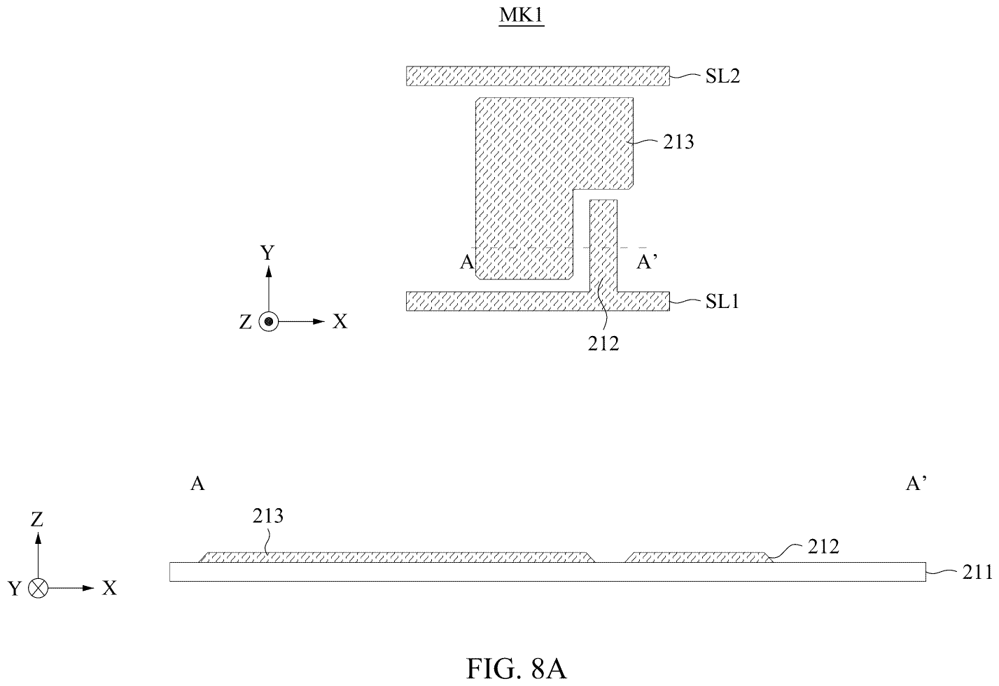

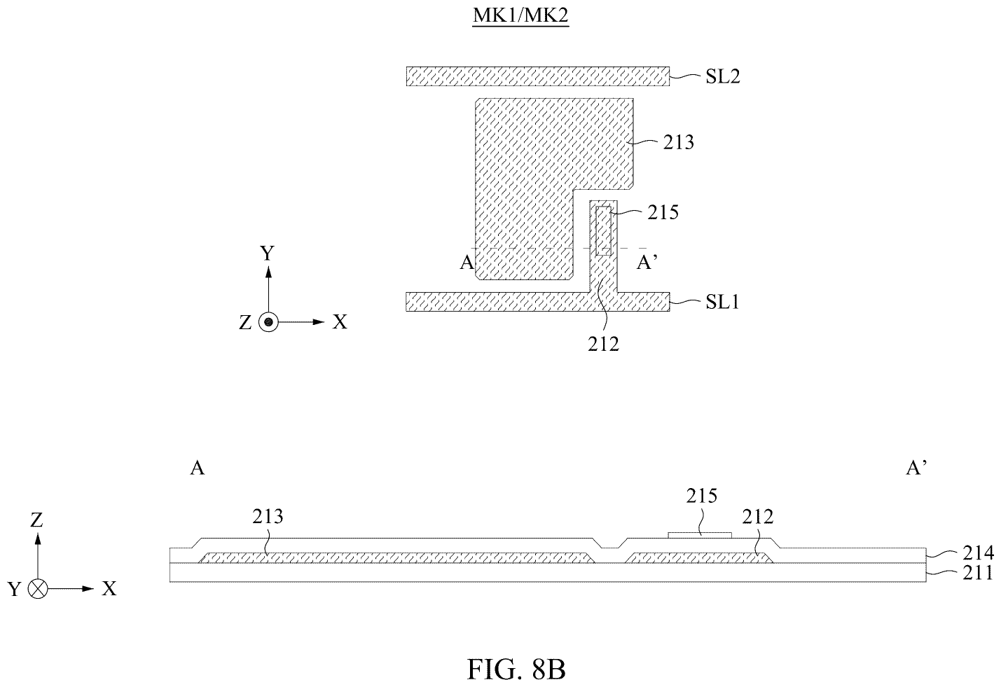

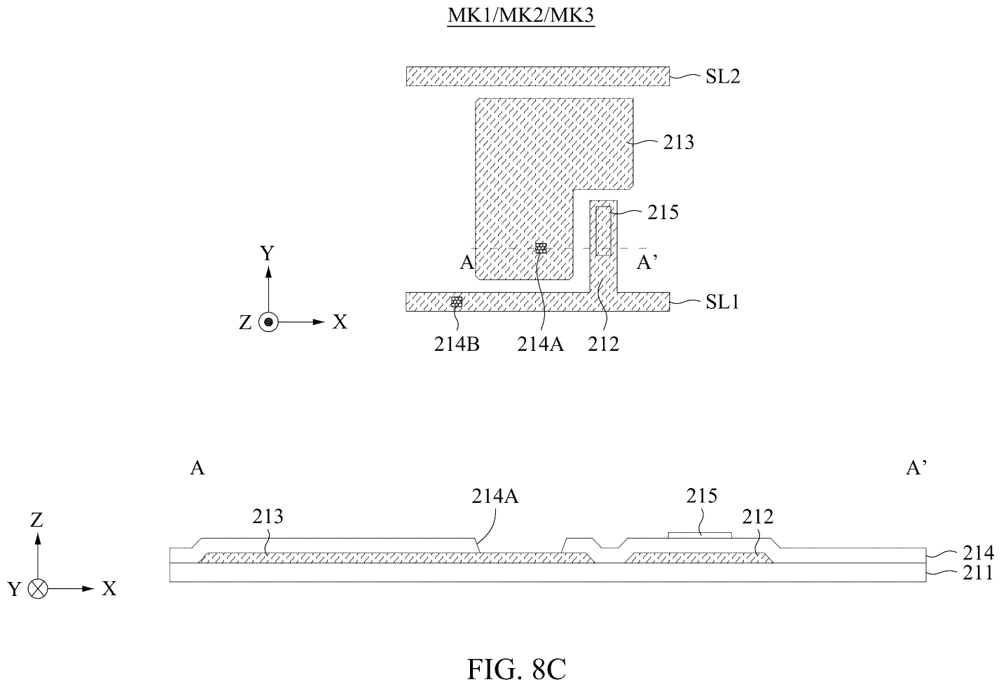

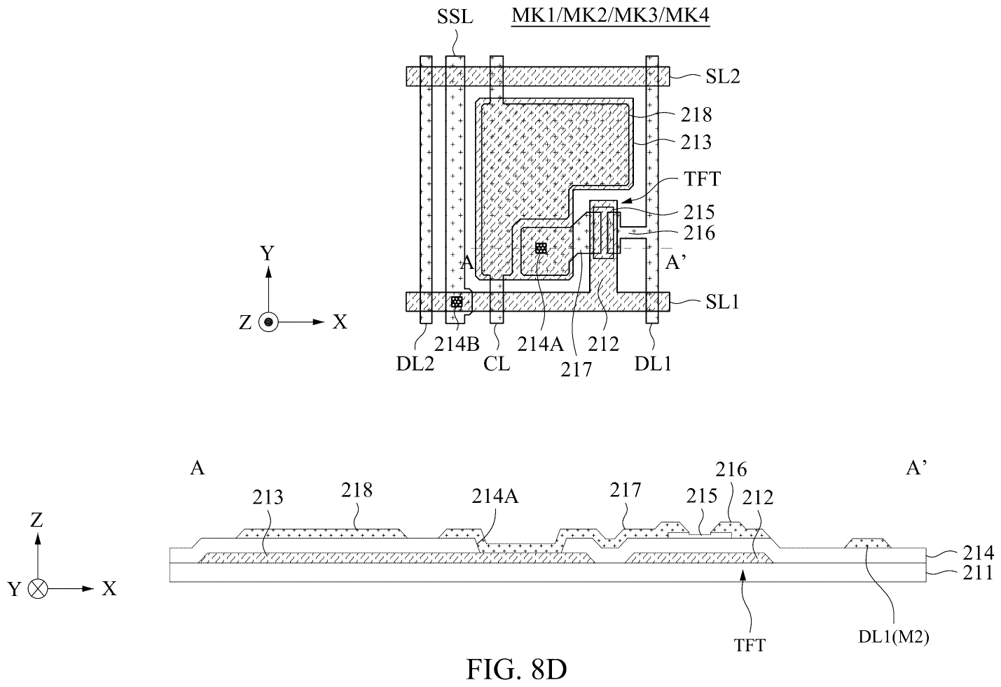

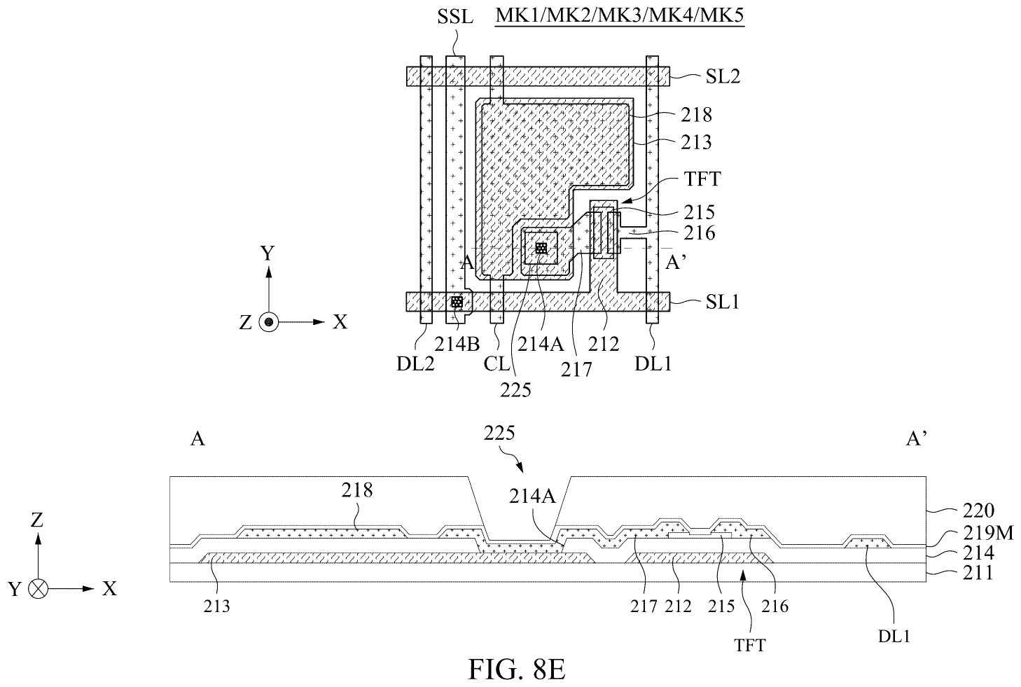

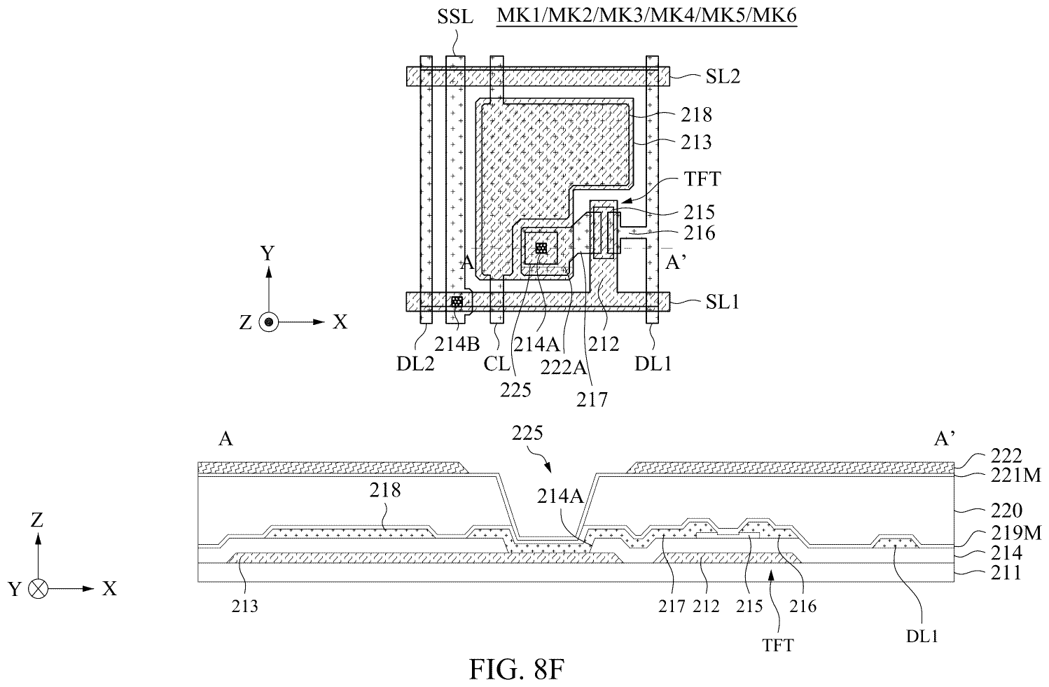

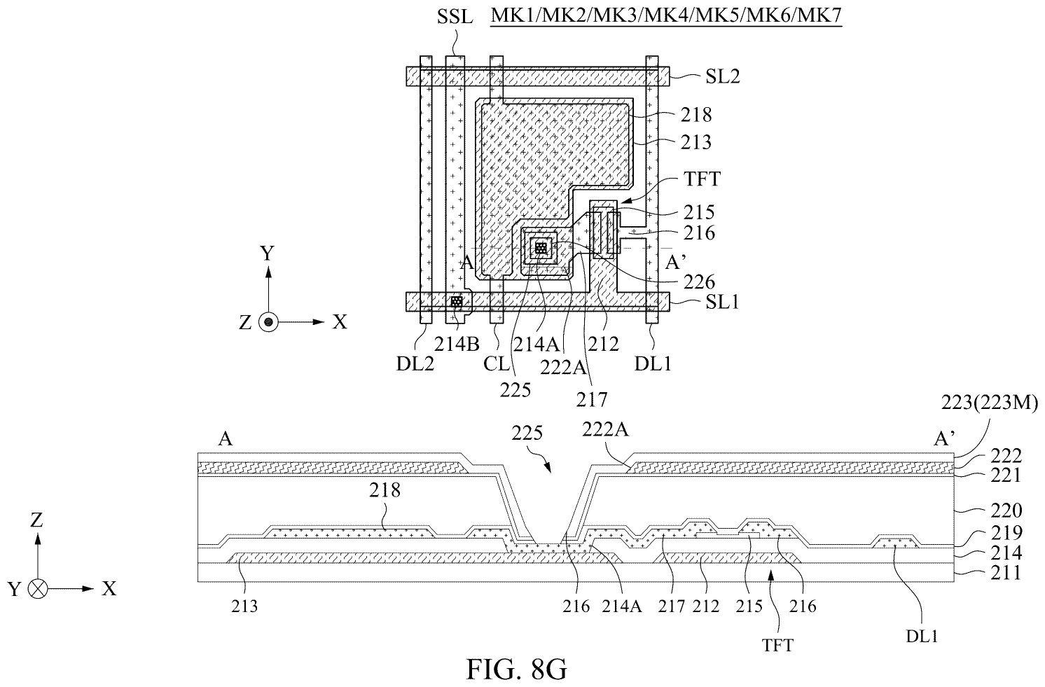

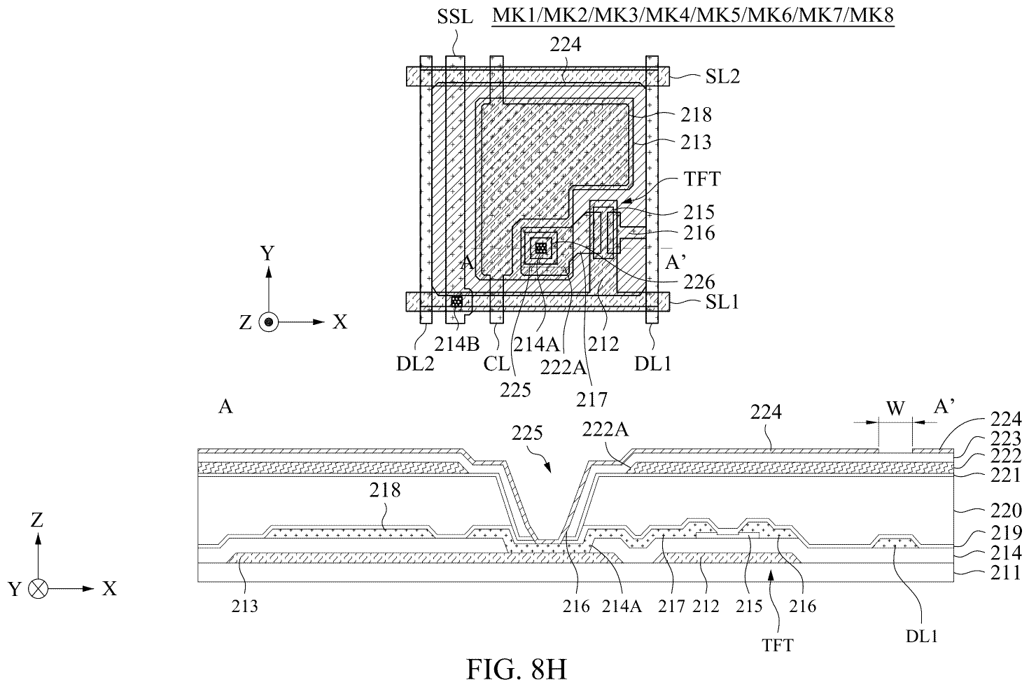

FIG. 7A is a schematic diagram of a processing table TB of each step for fabrication of the pixel array substrate structure 210 in FIG. 2. FIG. 7B is a schematic diagram of another processing table TB′ of each step for fabrication of the pixel array substrate structure 210 in FIG. 2. FIG. 8A to FIG. 8H are cross-sectional views and overlapping diagrams of photomasks of each step for fabrication of the pixel array substrate structure 210 in FIG. 2. The processing table TB in FIG. 7A and the processing table TB′ in FIG. 7B include the fabrication method of the pixel array substrate structure 210 of the display panel 200. Several steps are included in this method, and if each field of photomask corresponding to each step is denoted with a name of a photomask, this indicates that the named photomask is used in the lithography process of the step. If the field of lithography process corresponding to each step is denoted with “O,” this indicates that the step includes a lithography process. If the field of etching process corresponding to each step is denoted with “O,” this indicates that the step includes an etching process. Reference is made to FIG. 4A, FIG. 4B, FIG. 7A and FIG. 8A to FIG. 8H. The layout patterns of the first metal layer M1, the semiconductor layer 215, the through holes 214A, 214B, the second metal layer M2, the via 225, the shielding electrode layer M3, the through hole 226 and the pixel electrode layer PE in FIG. 4A and FIG. 4B may be used to fabricate the photomasks MK1-MK8, respectively. The reference labels M1 (MK1), 215 (MK2), 214A/214B (MK3), M2 (MK4), 225 (MK5), M3 (MK6), 226 (MK7) and PE (MK8) in FIG. 4A and FIG. 4B denote that the patterns of the first metal layer M1, the semiconductor layer 215, the through holes 214A, 214B, the second metal layer M2, the via 225, the shielding electrode layer M3, the through hole 226 and the pixel electrode layer PE may be a part of the patterns of the photomasks MK1-MK8, respectively. In addition, the reference label MK1/MK2 refers to the overlapping schematic diagrams of the first photomask MK1 and the second photomask MK2, while the reference label MK1/MK2/MK3 refers to the overlapping schematic diagrams of the first to third photomasks MK1-MK3. The rest of the reference labels are deduced in the same way, and an explanation thereof will not be provided.

In the fabrication method of the pixel array substrate structure 210, firstly, as shown in the first photomask MK1 of FIG. 4A, FIG. 7A and FIG. 8A, the first substrate 211 is provided, and the first metal material layer is deposited on the first substrate 211. Next, the first metal material layer is patterned by the process of lithography with the first photomask MK1 and the process of etching so as to form the first metal layer M1 which includes the scan line SL1, the scan line SL2, the gate 212 of the pixel transistor TFT and the first capacitor electrode 213. The first substrate 211 may be a rigid substrate including such as glass, quartz, ceramics, a combination of aforementioned materials or other similar insulation materials, or may be a flexible substrate including such as polyimide (PI), polyethylene terephthalate (PET) or other similar insulation materials, but the disclosure is not limited thereto. The material of the first metal layer M1 may include at least one metal element such as chromium, tungsten, tantalum, titanium, molybdenum, aluminum, copper, other similar elements or alloys or compounds which consist of a combination of aforementioned metal elements, but the disclosure is not limited thereto.

Next, as shown in the second photomask MK2 of FIG. 4A, FIG. 7A and FIG. 8B, the gate insulation layer 214 is formed on the first metal layer M1 and the first substrate 211, and then a semiconductor material layer is formed. Next, the semiconductor material layer is patterned by the process of lithography with the second photomask MK2 and the process of etching so as to form the semiconductor layer 215 on the gate 212 of the pixel transistor TFT. The material of the gate insulation layer 214 may be such as silicon oxide, silicon nitride, silicon oxynitride or other similar dielectric materials. The semiconductor layer 215 may include an undoped semiconductor layer. In addition, the semiconductor layer 215 may further include a doped semiconductor layer over the undoped semiconductor layer. The material of the undoped semiconductor layer may be amorphous silicon, monocrystalline silicon, polycrystalline silicon or other similar materials, while the material of the doped semiconductor layer may be doped amorphous silicon, doped monocrystalline silicon, doped polycrystalline silicon or other similar materials.

Next, as shown in the third photomask MK3 of FIG. 4A, FIG. 7A and FIG. 8C, the gate insulation layer 214 is patterned by the process of lithography with the third photomask MK3 and the process of etching so as to form the through hole 214A and the through hole 214B on the first capacitor electrode 213 and the scan line SL1, respectively.

Next, as shown in the fourth photomask MK4 of FIG. 4A, FIG. 7A and FIG. 8D, the metal is deposited on the gate insulation layer 214 and the semiconductor layer 215 so as to form a second metal material layer, and then the second metal material layer is patterned by the process of lithography with the fourth photomask MK4 and the process of etching so as to form the second metal layer M2 which includes the data line DL1, the data line DL2, the scan signal line SSL, the common line CL, the source 216 and the drain 217 of the pixel transistor TFT and the second capacitor electrode 218. In some embodiments where the semiconductor layer 215 further includes the doped semiconductor layer over the undoped semiconductor layer, the doped semiconductor layer is patterned by the aforementioned etching process of the second metal material layer so as to form an Ohmic contact layer. The material of the second metal layer M2 may be similar to the material of the first metal layer M1 and include at least one metal element, such as chromium, tungsten, tantalum, titanium, molybdenum, aluminum, copper other similar elements or alloys or compounds which consist of a combination of aforementioned metal elements, but the disclosure is not limited thereto.

Next, as shown in the fifth photomask MK5 of FIG. 4B, FIG. 7A and FIG. 8E, the first passivation material layer 219M is formed on the second metal layer M2, and then a photo-sensitive material is deposited on the first passivation material layer 219M so as to form an overcoat material layer. Next, the overcoat material layer is patterned by the process of lithography with the fifth photomask MK5 so as to form the overcoat layer 220 which has the via 225. The material of the first passivation material layer 219M may be dielectric materials, such as silicon oxide, silicon nitride, silicon oxynitride or other similar materials. The materials of the overcoat layer 220 may be organic dielectric materials, such as epoxy resin, acrylic resin, polyimide or other similar materials, but the disclosure is not limited thereto. In the embodiment, since the overcoat layer 220 includes photo-sensitive materials, the overcoat material layer may be patterned by the lithography process without etching process so as to form the overcoat layer 220 which has the via 225. Thus, the processes may be simplified.

Next, as shown in the sixth photomask MK6 of FIG. 4B, FIG. 7A and FIG. 8F, the second passivation material layer 221M is formed on the overcoat layer 220, and then the shielding electrode material layer is formed on the second passivation material layer 221M. The second passivation material layer 221M contacts the first passivation material layer 219M through the via 225. Next, the shielding electrode material layer is patterned by the process of lithography with the sixth photomask MK6 and the process of etching so as to form the shielding electrode layer M3 which includes the shielding electrodes 222 with the opening 222A. The material of the second passivation material layer 221M may be similar to the material of the first passivation material layer 219M which include such as silicon oxide, silicon nitride, silicon oxynitride or other similar dielectric materials. In addition, the material of the shielding electrode layer M3 may be similar to the material of the first metal layer M1 and/or the material of the second metal layer M2 and include at least one metal element, such as chromium, tungsten, tantalum, titanium, molybdenum, aluminum, copper, other similar opaque metals or alloys or compounds which consist of a combination of aforementioned metal elements, but the disclosure is not limited thereto.

Next, as shown in the seventh photomask MK7 of FIG. 4B, FIG. 7A and FIG. 8G, the third passivation material layer 223M is formed on the second passivation material layer 221M and the shielding electrode layer M3, while the third passivation material layer 223M contacts the second passivation material layer 221M through the via 225. Next, the third passivation material layer 223M, the second passivation material layer 221M and the first passivation material layer 219M are patterned by the process of lithography with the seventh photomask MK7 and the process of etching so as to form the third passivation layer 223, the second passivation layer 221 and the first passivation layer 219 with the through hole 226 which passes through the third passivation layer 223, the second passivation layer 221 and the first passivation layer 219 and exposes the drain 217 of the pixel transistor TFT. The reference label “223 (223M)” in FIG. 8G indicates that the third passivation layer 223 is formed from the third passivation material layer 223M by the patterning processes of lithography and etching. The material of the third passivation material layer 223M is similar to the material of the first passivation material layer 219M and/or the material of the second passivation material layer 221M and include such as silicon oxide, silicon nitride, silicon oxynitride or other suitable dielectric materials.

Referring to FIG. 7B, in the embodiment which omits the second passivation layer 221, the third passivation material layer 223M contacts the first passivation material layer 219M through the via 225 after the third passivation material layer 223M is formed. Next, the third passivation material layer 223M and the first passivation material layer 219M are patterned by the processes of lithography and etching with the seventh photomask MK7 so as to form the third passivation layer 223 and the first passivation layer 219 with the through hole 226 which passes through the third passivation layer 223 and the first passivation layer 219 and exposes the drain 217 of the pixel transistor TFT.

In the disclosure, instead of patterning the first passivation material layer 219M and the second passivation material layer 221M to form the first passivation layer 219 and the second passivation layer 221 with the through hole that exposes the drain 217 of the pixel transistor TFT after the first passivation material layer 219M and the second passivation material layer 221M are formed and before the shielding electrode layer M3 is formed, the through hole 226 is formed in the first passivation material layer 219M, the second passivation material layer 221M and the third passivation material layer 223M so as to form the first passivation layer 219, the second passivation layer 221 and the third passivation layer 223 by the process of lithography with one photomask (i.e., the seventh photomask MK7) and the process of etching after the shielding electrode layer M3 and the third passivation material layer 223M are formed. Specifically, instead of using at least one photomask to pattern the second passivation material layer 221M and the third passivation material layer 223M in at least one patterning process step and using another photomask to pattern the first passivation material layer 219M in another patterning process step, only one mask and only one patterning process step are provided to pattern the first passivation material layer 219M, the second passivation material layer 221M and the third passivation material layer 223M in the disclosure. Thus, the fabrication of the photomask only for the patterning process of the first passivation material layer 219M and the photomask only for the patterning process of the second passivation material layer 221M may be omitted, and the processes of lithography and etching only for patterning the first passivation material layer 219M and the processes of lithography and etching only for patterning the second passivation material layer 221M may be omitted, so that the cost of the fabrication may be reduced.

Next, as shown in the eighth photomask MK8 of FIG. 4B, FIG. 7A and FIG. 8H, the pixel electrode material layer is formed on the drain 217 of the pixel transistor TFT, the first passivation layer 219, the second passivation layer 221 and the third passivation layer 223, and then the pixel electrode material layer is patterned by the processes of lithography and etching with the eighth photomask MK8 so as to form the pixel electrode layer PE which includes the pixel electrodes 224. The material of the pixel electrode layer PE may include at least one transparent conductive material, such as indium tin oxide (ITO) and/or indium zinc oxide (IZO), but the disclosure is not limited thereto.

It should be noted that, although the schematic layout diagrams and cross-sectional views in FIG. 8A to FIG. 8H illustrate only one pixel PX and a part of the layout patterns of adjacent pixels thereof, a person having ordinary skill in the art to which the disclosure pertains should understand that the layout patterns and cross-sectional views of those pixels not shown are the same as or similar to the layout patterns and cross-sectional views of each step in FIG. 8A to FIG. 8H.

After the fabrication of the pixel array substrate structure 210 is completed, the opposite substrate structure 230 as shown in FIG. 2 is provided, and then the pixel array substrate structure 210 and the opposite substrate structure 230 are assembled so as to form the display panel 200. The electrophoretic layer 250 is between the pixel array substrate structure 210 and the opposite substrate structure 230.

Similar to the first substrate 211 of the pixel array substrate structure 210, the second substrate 231 may be a rigid substrate consist of such as glass, quartz, ceramics, the combination of aforementioned materials or other similar insulation materials, or may be a flexible substrate including such as polyimide (PI) or polyethylene terephthalate (PET), but the disclosure is not limited thereto. In addition, the material of the common electrode layer 232 may be transparent conductive material, such as indium tin oxide (ITO) or indium zinc oxide (IZO), but the disclosure is not limited thereto. In some embodiments, the opposite substrate structure 230 further includes the color resist film and covering film (not shown). The materials of the color resist film may be photoresist materials, such as the combination of pigments and photo-cured resins, while the materials of the covering film may be organic or inorganic dielectric materials.

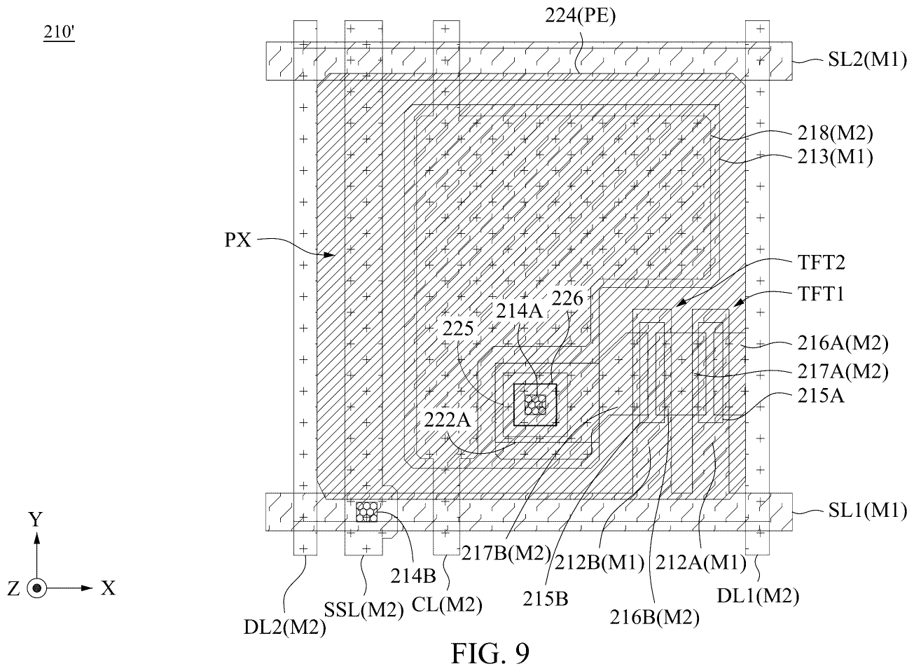

FIG. 9 is a schematic layout diagram of a pixel array substrate structure 210′ in accordance with another embodiment of the invention. The difference between the pixel array substrate structure 210′ and the pixel array substrate structure 210 in FIG. 3A and FIG. 3B is that each pixel PX of the pixel array substrate structure 210′ has a first pixel transistor TFT1 and a second pixel transistor TFT2. The pixel transistor TFT1 includes a gate 212A, a semiconductor layer 215A, a source 216A and a drain 217A, while the pixel transistor TFT2 includes a gate 212B, a semiconductor layer 215B, a source 216B and a drain 217B. The source 216A of the pixel transistor TFT1 is coupled to the data line DL1, while the drain 217A of the pixel transistor TFT1 is coupled to the source 216B of the pixel transistor TFT2. The drain 217B of the pixel transistor TFT2 is coupled to the pixel electrode 224, while the gate 212A of the pixel transistor TFT1 and the gate 212B of the pixel transistor TFT2 are coupled to the scan line SL1. The gate 212A of the pixel transistor TFT1 and the gate 212B of the pixel transistor TFT2 belong to the first metal layer M1, while the source 216A and the drain 217A of the pixel transistor TFT1 and the source 216B and the drain 217B of the pixel transistor TFT2 belong to the second metal layer M2. The other components in the pixel array substrate structure 210′ may be identical to the corresponding components in the pixel array substrate structure 210, so that the descriptions of these components are disclosed in the description of the pixel array substrate structure 210 and will not be repeated herein. In some embodiments, due to the pixel transistor TFT1 and the pixel transistor TFT2 which are coupled to each other, the electrical leakage may be reduced so as to improve the quality of images. As a result, the disclosure is especially applied to low-frequency display devices, but the disclosure is not limited thereto. In addition, since the charging time of a low-frequency display device is long, the pixel electrodes of the pixels PX with double pixel transistors in the embodiment may be charged to a predetermined potential.

It should be noted that the feature in which the shielding electrodes 222 of the disclosure cover the data lines DL and the scan lines SL in the vertical projection direction so as to shield the pixel electrodes 224 from the interference of the signals of the data lines DL and the scan lines SL may be applied to the embodiment which is without the scan signal lines SSL. That is, the pixel array substrate structures of the aforementioned embodiments may be without the scan signal line SSL and the through hole 214B.

As can be seen from the above description, by utilizing the special design for the gate driving circuit, the invention can reduce the border width of the display device and/or increase the layout area of the other circuits in the display device and can effectively reduce power consumption.

What is claimed is:

1. A pixel array substrate structure, comprising:
a substrate;
a first metal layer over the substrate and having a plurality of scan lines;
a second metal layer over the first metal layer and having a plurality of data lines, wherein the plurality of scan lines and the plurality of data lines define a plurality of pixel areas;
a shielding electrode layer over the second metal layer and comprising a plurality of shielding electrodes that are located in the plurality of pixel areas, respectively, and cover the plurality of scan lines and the plurality of data lines in a vertical projection direction of the substrate; and
a pixel electrode layer over the shielding electrode layer and having a plurality of pixel electrodes that are located in the plurality of pixel areas, respectively.

2. The pixel array substrate structure of claim 1, wherein one of the plurality of pixel electrodes overlaps at least one of the plurality of scan lines in the vertical projection direction.

3. The pixel array substrate structure of claim 1, wherein an edge of one of the plurality of pixel electrodes is aligned with an edge of one of the plurality of data lines in the vertical projection direction.

4. The pixel array substrate structure of claim 1, wherein one of the plurality of pixel electrodes overlaps at least one of the plurality of data lines in the vertical projection direction.

5. The pixel array substrate structure of claim 1, wherein a width of a spacing between two of the plurality of pixel electrodes that are adjacent to each other is less than or equal to 5 μm.

6. The pixel array substrate structure of claim 1, further comprising:
a first pixel transistor and a second pixel transistor, wherein a source of the first pixel transistor is coupled to one of the plurality of data lines, and a drain of the first pixel transistor is coupled to a source of the second pixel transistor, and a drain of the second pixel transistor is coupled to one of the plurality of pixel electrodes, and a gate of the first pixel transistor and a gate of the second pixel transistor are coupled to one of the plurality of scan lines.

7. The pixel array substrate structure of claim 1, wherein the second metal layer further has a plurality of scanning signal lines that are coupled to the plurality of scan lines, respectively, and the plurality of scanning signal lines are substantially parallel to the plurality of data lines.

8. The pixel array substrate structure of claim 1, wherein the first metal layer further has a plurality of first capacitor electrodes, the second metal layer further has a plurality of second capacitor electrodes, and the plurality of first capacitor electrodes and the plurality of second capacitor electrodes are located in the plurality of pixel areas.

9. An electrophoretic display device, comprising:
the pixel array substrate structure of claim 1;
an opposite substrate structure comprising:
a second substrate; and
a common electrode layer disposed on the second substrate; and
an electrophoretic layer between the pixel electrode layer and the common electrode layer.

10. A fabrication method of a pixel array substrate structure, comprising:
forming a first metal layer over a substrate, the first metal layer having a plurality of scan lines;
forming a second metal layer over the first metal layer, the second metal layer having a plurality of data lines, wherein the plurality of scan lines and the plurality of data lines define a plurality of pixel areas;
forming a shielding electrode layer over the second metal layer, the shielding electrode layer comprising a plurality of shielding electrodes that are located in the plurality of pixel areas, respectively, and the plurality of shielding electrodes covering the plurality of scan lines and the plurality of data lines in a vertical projection direction of the substrate; and
forming a pixel electrode layer over the shielding electrode layer, the pixel electrode layer having a plurality of pixel electrodes that are located in the plurality of pixel areas.

11. The method of claim 10, further comprising:
forming a passivation material layer over the second metal layer;
forming an overcoat layer over the passivation material layer, wherein the overcoat layer has a via;
forming another passivation material layer over the shielding electrode layer; and
forming a through hole in the passivation material layer and the another passivation material layer, wherein the through hole passes through the passivation material layer and the another passivation material layer, and the through hole overlaps the via in the vertical projection direction.
